(19) United States
(12) Patent Application Publication
(10) Pub. No.: US 2012/0304072 A1
(43) Pub. Date: Nov. 29, 2012

(54) SENTIMENT-BASED CONTENT AGGREGATION AND PRESENTATION

(75) Inventors: Marc E. Mercuri, Bothell, WA (US); James O. Tisdale, Duvall, WA (US)

(73) Assignee: Microsoft Corporation, Redmond, WA (US)

(21) Appl. No.: 13/113,085

(22) Filed: May 23, 2011

(51) Int. Cl. G06F 3/048

(52) U.S. Cl. 715/745

(57) ABSTRACT

A content partitioning system is described herein that receives content and automatically determines sentiment information about the content that affects how the content will be displayed. The system can combine sentiment and moderator controls to automatically segregate users by their previous interactions so that they are presented with a subset of content on the site and their influence on the rest of the content is thereby minimized. Upon receiving a request by another user to display content in a forum, the content partitioning system conditionally displays each item based on a variety of criteria. In this way, one group of users can have a reasoned discussion in the same forum that another group of users is behaving badly. Thus, the content partitioning system provides automated moderation of online content that allows discussions to continue in a manner particularly tailored to each user.

### BACKGROUND

The Internet is filled with many different types of content, such as text, video, audio, and so forth. Many sources produce content, such as traditional media outlets (e.g., news sites), individual bloggers, online forums, retail stores, manufacturers of products, and so forth. Some web sites aggregate information from other sites. For example, using a Really Simple Syndication (RSS) feed, a web site author can expose his content for other sites to include or for users to consume, and an aggregating site can consume various RSS feeds to provide aggregated content.

Sentiment refers to any qualitative assessment of content that provides information about the content (e.g., metadata) separate from the content itself. Content publishers often provide a facility for rating content or receiving a sentiment about the content from a user (e.g., positive, negative, or some scale in between). For example, a video may include a display of five stars that a user can click on to rate the video from one to five stars. Publishers may also display a rating based on input from multiple users and use ratings in searches (e.g., to return the highest rated content or sort content by rating) or other workflows. Organizations may internally or externally rate content, such as determining which advertising campaign among several choices will be most effective for a target demographic. Software can also automatically rate the sentiment of received content, such as by detecting keywords, syntax, volume, history of views, and so forth. In the world of the real-time web, it is useful for organizations to receive contextually relevant evaluation of content.

Internet forums and other online gathering places are increasingly becoming places where people interact and share a variety of information. Forums are often devoted to any number of topics, including product discussions, political information, hobbies, and so on. Forums can become places where brands are discussed and where an organization's reputation can be affected by “word-of-mouth” communications, or places where people share and form political views or debate policies. Numerous forums exist where reviews can be posted and where users can discuss experiences with particular companies. Some users have even created web sites with the specific purpose of discussing good or bad experiences with a particular company or promoting/debunking a particular policy. Forums also provide a growing place for political discussions and sharing of other opinions to take place.

When hosting a large opinion or feedback site on the internet that generates feedback around controversial topics, there is a tendency for organized groups to attempt to hijack or take over the debate in a manner that spoils the forum. For example, members of one political party interacting on a site to discuss their ideas may frequently be interrupted by a member of another political group that does not like their ideas and chooses to try to make the forum unsuitable for discussion. They may do that by posting spam, flooding the forum with off-topic comments, masquerading as various other users, and so forth. Although forums are generally seen as a place to share many viewpoints, viewpoints can be expressed in a negative manner that precludes reasoned discussion, which then decreases the forum's usefulness as a mode of communication. Past attempts to solve this problem include moderating the forum, in which a human moderator receives each post before it is displayed on the forum to approve or deny the post based on whether it is suitable according to the moderator's view of the forum's purpose. However, forums are becoming very large and finding enough good moderators to handle the volume without delaying uploading of content is a difficult challenge.

### SUMMARY

A content partitioning system is described herein that receives content and automatically determines sentiment information about the content that affects how the content will be displayed. The system can combine sentiment and moderator controls to automatically segregate users by their previous interactions so that they are presented with a subset of content on the site and their influence on the rest of the content is thereby minimized. The system can segregate a bad user or the user's individual posts, and then transparently decide whether other users will see negatively rated content. Upon receiving a request by another user to display content in a forum, the content partitioning system conditionally displays each item based on a variety of criteria. The system can be configured with a variety of rules that define how content is displayed. In this way, one group of users can have a reasoned discussion in the same forum that another group of users is behaving badly. The users having a reasoned discussion will see each other's' posts but will not see posts from the badly behaving users, while the shouting users may see all of the posts or just posts similar to theirs. Thus, the content partitioning system provides automated or assisted moderation of online content that allows discussions to continue in a manner particularly tailored to each user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the content partitioning system, in one embodiment.

FIG. 2 is a flow diagram that illustrates processing of the content partitioning system to display online content to a user of an information system, in one embodiment.

FIG. 3 is a flow diagram that illustrates processing of the content partitioning system to receive online content from an author for display to other users of an information system, in one embodiment.

### DETAILED DESCRIPTION

A content partitioning system is described herein that receives content and automatically determines sentiment information about the content that affects how the content will be displayed. The system can combine sentiment and moderator controls to automatically (and optionally with some intervention) segregate users by their previous interactions so that they are presented with a subset of content on the site and their influence on the rest of the content is thereby minimized. The system can segregate a bad user or the user's individual posts, and then transparently decide whether other users will see negatively rated content. For example, in a discussion where a bad user begins posting spam to flood the discussion with irrelevant material, the system may detect the nature of the user (e.g., by automatically analyzing the content and determining that it is spam), and mark the content as spam (or other classification). Upon receiving a request by another user to display content in a forum, the content partitioning system conditionally displays each item based on a variety of criteria. The system can be configured with a variety of rules that define how content is displayed. For example, a user may see that user's own posts, but other users may not see the posts depending on a classification of the posts determined by the system. The system may choose to display inflammatory posts to all users determined to be inflammatory, but not to users that are not known to be problematic. In this way, one group of users can have a reasoned discussion in the same forum that another group of users is having a shouting match, so to speak. The users having a reasoned discussion will see each other's' posts but will not see posts from the shouting users, while the shouting users may see all of the posts or may simply see the posts of other people “shouting”. By this method, bad actors can continue to participate in the system all the while unaware that they are only communicating with other bad actors (or people of similar belief).

In some embodiments, the content partitioning system is implemented as a plugin to existing forum-hosting software. One example of online forum software is MICROSOFT™ TownHall. Following is an example walkthrough of a use of the system. A politically conservative web site, hosted on Microsoft TownHall is seeking opinions on ideas for legislation. A left wing outside group directs its membership to sign up and sway the debate on the site with ideas for legislation that they favor, ideas that would not be favorable to the hosts of the site. Using the content partitioning system, an individual that meets certain criteria (e.g., has a number of ideas voted down, is tagged by a moderator, consistently uses certain keywords, reaches a specific aggregate sentiment score, and so on) is presented with topics that more closely meet with their criteria. This groups like-minded people together and limits the continued influence across these groups. This is an example of presenting content to the individual that is adapted to that individual's preferences or attributes. In this example, whole forum topics are invisible to users that do not have an appropriate stake or position with respect to the discussion, so that users likely to be highly at odds are not allowed to interact. The system can also operate on content submissions of the users, so that each submission is flagged as suitable for particular groups, and shown only to appropriate groups. Thus, the content partitioning system provides automated or assisted moderation of online content that allows discussions to continue in a manner particularly tailored to each user.

The content partitioning system detects errant users or errant posts and provides a walled garden so that an online content sharing site is not spoiled by the influence of errant users. The influence of the errant users is minimized in a way that is transparent to users of the content sharing site, even the errant user himself. Errant users often derive a certain pleasure from their activities, and preventing the user from venting on the site can increase the motivation for the user to attempt to inflict damage upon the site. Often, errant users will enlist the help of other groups to which they belong to join in bringing down a site with which they have a problem. By transparently minimizing the influence of errant users, the content partitioning system provides these users with the apparent pleasure of still posting their content, while hiding this content from other users of the site. The errant user may see the content he has posted and think that everyone sees the content, even while the content is hidden from most users. The site may also display the content to other friends of the errant users so that they all believe they have succeeded in influencing the discussion or spoiling the site, when in fact they are all visiting the same walled garden of content that is not seen by other users.

The content partitioning system can use a variety of inputs to determine sentiment classifications for particular users and content. For example, the system may detect votes by other users that rate the content or user, moderator tagging that leverages traditional moderators to enhance the value of the system, keywords in content that indicate inflammatory material, a sentiment score output by another system, social networks of particular users to which the users give the site operator access, known lists of bad users shared between sites, or any other source of classifying users and content. The system may also score content and users on a positive basis, so that users that post good and helpful content receive an increasing reputation. In some embodiments, the system may partition new users that join a site into a trial group that does not influence ongoing discussions between high reputation members (e.g., members of high reputation do not see the new members' posted content). As a new user's reputation increases based on the approval of other new users (that do see the user's content posts) or other automated rating criteria, the system may take the user out of the trial group and allow all members to see that user's posts. This is an effective way for a content site to ensure a high caliber of discussion while allowing everyone to participate to some level.

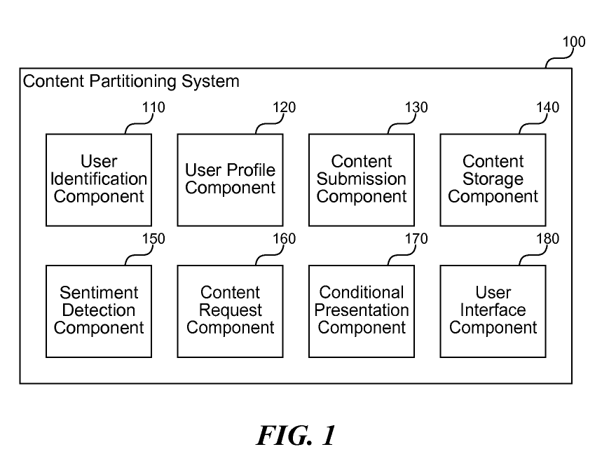

FIG. 1 is a block diagram that illustrates components of the content partitioning system, in one embodiment. The system 100 includes a user identification component 110, a user profile component 120, a content submission component 130, a content storage component 140, a sentiment detection component 150, a content request component 160, a conditional presentation component 170, and a user interface component 180. Each of these components is described in further detail herein.

The user identification component 110 identifies users that interact with the system. The system 100 uses the identity of users at two points: the content submission phase and the content viewing phase. Upon receiving a request to view content, the user identification component 110 determines the viewing user's identity, selects appropriate content for the user (e.g., by applying any filtering determined based on the user's characteristics), and displays the content to the user. Upon receiving a content submission, the user identification component 110 determines the submitting user's identity, invokes the content submission component 130 to evaluate the content (e.g., through ratings, categorization, and so forth), and then stores the submitted content. The user identification component 110 may identify users in a variety of ways, such as by receiving login information from the user (e.g., directly or via a previous login and cookie) and loading a user profile using the user profile component 120. The system 100 may also allow some users to remain anonymous (e.g., unregistered visitors to a website), and may determine appropriate content to display to users in such a group.

The user profile component 120 stores user information across user sessions with the system. The user profile may include a data store such as one or more files, file systems, databases, hard drives, cloud-based storage services, or other storage facilities. The user profile component 120 stores a variety of information about the user, such as characteristics manually or automatically determined that inform the system's decisions on how to rate and display content from the user. For example, a user's profile may include information about the user's group affiliations (e.g., political party), historic rating of content (e.g., from other users, automated processes, and so forth), time spent using the system 100, identity (e.g., email address, name, age, gender), socioeconomic status, and so on. The user profile component 120 provides information to other components of the system to make decisions about how a particular user's content is rated and displayed. The system 100 may also derive additional ratings of the user based on the profile information, such as classifying a particular user as troublesome or a valued contributor. The system 100 then uses this information to display content appropriately to other users.

The content submission component 130 receives from a user a submission of content for publication to other users. The system 100 may provide a web-based or other interface through which content can be received, and upon receiving content, the system 100 invokes the content submission component 130 to handle content intake. The submission process may include storing information about the user that submitted the content and other circumstances of the submission (e.g., time, forum topic, prior related posts, and so on). The component 130 may also perform an initial automated review of the content (e.g., based on keywords, natural language processing (NLP), or other criteria) or mark the content for additional stages of review, so that the content can be classified based on its content and suitability for display to particular groups of users. Unlike prior systems, the content partitioning system 100 does not generally make a binary decision between posting and deleting the content, but rather makes a more detailed decision about which users or groups of users will be able to view the submitted content. In many cases, at least the user that submitted the content will be able to view the content, and potentially other users like the submitting user will be able to view the content, even if the system 100 decides to block the content from other users. Although the system 100 may include some criteria for blocking all content that matches the criteria (e.g., content that includes obscene material), most content will be allowed to display to at least some users of the system 100.

The content storage component 140 stores submitted content for subsequent viewing by users of the system. The content storage component 140 includes one or more data storage facilities, such as those used by the user profile component 120. The content storage component 140 may include a database or other storage of past-posted content, along with any metadata such as content ratings attached to the content by the content submission component 130, system administrators, user voting, or others. The content storage component 140 may also provide facilities for administrators or content posters to edit, delete, or otherwise modify previously posted content.

The sentiment detection component 150 evaluates submitted content based on one or more sentiment criteria, and rates the content for suitability for display to particular users or groups of users. The component 150 may include one or more automated (e.g., keyword or other language processing and leveraging user profile information) or manual (e.g., moderator influence and/or user ratings) processes to rate the sentiment of submitted content. Users of the system 100 may help the system tune a baseline rating by providing feedback about the accuracy of the automatic rating in the user's opinion. The component 150 may employ multiple automatic methods of rating content, and may combine the scores of multiple methods (e.g., averaging). In addition, the component 150 receives tuning information based on received user ratings over time that the component 150 can use to improve the quality and accuracy of baseline automatic sentiment ratings.

In some embodiments, the sentiment detection component 150 optionally applies a weighting factor to the rank of each content entry based on a user associated with the entry. For example, an entry from a well-established and respected user may have a higher weighting factor than a new user or a user known to post high-spam content. The weighting factor allows the system 100 to factor in a subjective reliability or reputation of a source in addition to the objective rank determined by the component 150.

In some embodiments, the sentiment detection component 150 receives supplemental rating information from human moderators that indicate whether particular content items are suitable for publishing or not and to which types of users. Moderators may evaluate the content, apply additional metadata tags, and make a determination of how to classify the content. In some embodiments, the system 100 may publish content after automated review by the sentiment detection component 150 to allow fast update of forums and then allow later moderation to lazily remove or reclassify content that is determined to be unsuitable or less targeted to a particular group of users. Alternatively or additionally content may wait in a queue for human moderation and only be published after explicit approval. Human moderators may flag content items with additional tags such as forums for which the content items are relevant.

The content request component 160 receives one or more requests to display content items to a user. A user may visit a website that provides online forums, a blog, a review site, or any other information system that leverages the content partitioning system 100 to display content to users. The content request component 160 invokes the user identification component 110 to determine an identity of the user and any characteristics or groupings of the users that may affect the content items that the system 100 displays to the user. The content request component 160 performs the initial processing of determining the user's identity and loading potential content items that the user may view, and passes this information to the conditional presentation component 170 to determine any content items to filter from the user's view.

The conditional presentation component 170 determines one or more content items to filter from a user's view of content stored by the system. In an online forum, the content items may include individual forum posts. On a blog, the content items may include blog posts or comment entries. Depending on the type of information system, the content partitioning system 100 can be implemented to provide an appropriate level of content moderation. The conditional presentation component 170 identifies when a particular user and a particular content item are incompatible for one reason or another. For example, the component 170 may determine that the content item would offend the user, that the content item would waste the user's time, that the content item is not germane to the current topic, and so forth. In this way, the conditional presentation component 170 ensures that the user's experience while using the information system is a pleasant one that includes easy access to the content the user wants to see and automated filtering of the content that the user has less interest in or no reason to see. The conditional presentation decisions made by the component 170 will often vary from user to user, as the system 100 attempts to present similar content to users that meet similar criteria.

The user interface component 180 provides one or more user interfaces through which the system interacts with users of the system. The user interface component 180 may provide a moderator/admin interface, a content display interface, a user configuration interface, a content submission interface, and so forth. The user interface component 180 may include one or more types of interfaces for difference client devices or platforms, such as web-based interfaces, mobile device interfaces, desktop computing interface, touch-based interfaces, and so forth. The user interface component 180 receives input from one or more users, invokes appropriate components of the system to respond to the user's request, and displays output from the components to the user. In cases where content is filtered from the user's view, the system 100 may provide user interface controls for “un-hiding” filtered content so that the user can evaluate how well the system 100 has partitioned content on the user's behalf. The system may also 100 provide controls through which the user can rate or otherwise mark a particular content item for reevaluation to be displayed to the user and other similar users.

The computing device on which the content partitioning system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

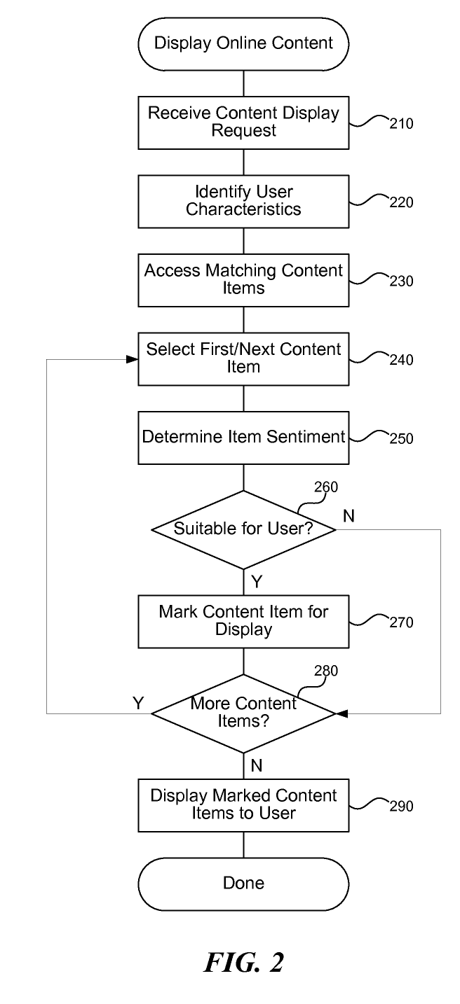

FIG. 2 is a flow diagram that illustrates processing of the content partitioning system to display online content to a user of an information system, in one embodiment. Beginning in block 210, the system receives a request to display content for a user. For example, a user may visit a web page associated with the system using a web browser running on a client device such as a mobile phone or desktop computer. The request may include information describing a type of content the user wishes to access, such as a particular forum or discussion thread of an online forum.

Continuing in block 220, the system identifies one or more user characteristics associated with the requesting user that determine content suitable for display to the user. For example, the system may access a user profile of the user that includes information about the user's age, political affiliation, past history with the system, and so forth. In some cases, the system may determine that the user is an unregistered or anonymous user and apply default characteristics or dynamically determine characteristics of the user (such as through a brief questionnaire presented to the user or through automatically identifiable information about the user).

Continuing in block 230, the system accesses one or more content items that fulfill the received request. For example, the system may retrieve a list of forum posts for an online forum that the user is requesting to access or a list of forum topics available for the forum. The system may access the items from a database or other storage facility that stores content items previously submitted by the user or other users of the system. The content items may include text, pictures, audiovisual content, or any other type of content presented by the information system.

Continuing in block 240, the system selects the first accessed content item. The system iterates through each accessed content item and performs the subsequent steps to determine whether each content item will be displayed. During subsequent iterations, the system selects the next accessed content item at block 240.

Continuing in block 250, the system determines a sentiment indication associated with the selected content item. For example, the system may have determined and assigned characteristics describing the selected content item upon submission of the item to the system. The system may also determine the sentiment of content items “on the fly” as they are accessed or based on a cache of previously determined item sentiment. Those of ordinary skill in the art will recognize numerous variations for efficiently and scalably retrieving information to achieve the purpose of the system.

Continuing in decision block 260, the system compares the determined sentiment with the identified user characteristics and if the system determines that the selected content item is suitable display for the user, the system continues in block 270, else the system jumps to block 280. The system matches content items to users based on a variety of criteria that determine whether a particular user is likely to be interested in the content item. The criteria may determine whether the content item is likely to be offensive to the user or wasteful of the user's time so that the system avoids presenting items to the user from which the user will not derive a threshold level of value.

Continuing in block 270, the system marks the selected content item for display to the user. The system may display items as it goes or process each of the items and send an indication to the client of which items to display to the user. In some cases, the latency and cost of sending information to the client may determine how the system processes items for display. Nevertheless, the result is that the system partitions content items such that some are displayed to the user and others are not based on criteria set up by the system implementer or operator.

Continuing in decision block 280, if there are more accessed content items, then the system loops to block 240 to consider the next content item, else the system continues to block 290 after the set of content items has been processed.

Continuing in block 290, the system displays the marked content items to the requesting user in response to the user's request. The displayed items may exclude those items that the system determined were not suitable for display to the user, so that some users may see certain content items that others do not see. In this way, the system allows users to participate and access the same information system but the system can apply a level of filtering to segregate users that do not interact well together or to block content from users that will not find the content helpful. After block 290, these steps conclude.

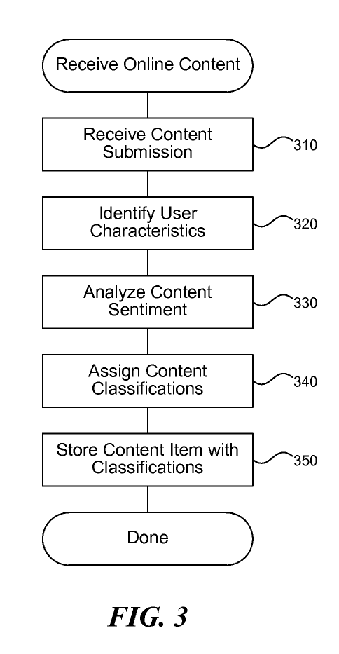

FIG. 3 is a flow diagram that illustrates processing of the content partitioning system to receive online content from an author for display to other users of an information system, in one embodiment. Beginning in block 310, the system receives a content submission from an author. The submission may include one or more types of content, such as text, links, images, and so on. The submission also includes information about the user that submitted the content. Even if the information system allows anonymous users to submit content, that information accompanies the content submission and is used by the content partitioning system to characterize the submission.

Continuing in block 320, the system identifies one or more characteristics of the content submission and the author that submitted the content. The identified characteristics may include whether the content includes particular keywords, links to particular online sites, identifiable images, whether the author has a high reputation with the information system, affiliations of the author, and so forth. The system may retrieve information from a user profile of the author to determine characteristics as well as dynamically determining some characteristics based on analysis of the content and/or author.

Continuing in block 330, the system analyzes a sentiment of the submitted content to determine one or more classifications to which the content is related. The system may perform automated analysis, such as keyword matching, natural language processing, pattern matching, and so forth, as well as manual analysis, such as submitting the content for human moderation.

Continuing in block 340, the system assigns one or more content classifications to the received content that partition various content submissions between one or more classes of users to which to display the content. For example, the system may classify a content submission with negative classifications such as spam, repetitive, offensive, or aggressive, or positive classifications, such as well cited, from a respected author, informative, and so on.

Continuing in block 350, the system stores the received content submission along with the assigned content classifications in a data store from which the content submission can be accessed upon receiving a request to display the content submission. The system stores content items with enough information to allow for efficient display of items to users and for determining to which users to display the items. The system may perform some analysis at the time of submission and other analysis at the time of display as needed for efficient and scalable implementation of the system. After block 350, these steps conclude.

In some embodiments, the content partitioning system allows individual users to configure classifications of content that the system will present to them. A user that is very tolerant of all kinds of content and that does not want to miss any of a discussion may configure settings that prevent the system from hiding any content from the user. Conversely, a user with little time or patience for off-topic material may configure settings that cause the system to stringently limit the content presented to the user to only the most highly relevant content.

In some embodiments, the content partitioning system partitions content with detailed classifications that go beyond a simple binary “good” or “bad” evaluation. For example, the system may assess the general tone of content (e.g., pensive, inflammatory, affirming a previous comment, redundant, and so forth), and then filter content based on a variety of criteria. Some users may not want to see content that is redundant, and may request that the system filter out “me, too” types of posts or simple “thanks” messages. This content is not inflammatory or harmful, but may still frustrate other users that have little time or simply want to be presented with comments that add something significant to the discussion. Classifications may also affect users, and may include a variety of information such as political affiliation, gender, age, social groups, and so on. The system may allow users to configure whether they see posts from users that fit certain criteria. For example, a liberal reading a discussion group may not want to see posts from conservatives, or a forum of senior citizens may choose to filter out posts from users below a certain age. The content partitioning system provides the tools for content site operators to filter content based on a variety of criteria and to satisfy any number of goals specific to the site.

In some embodiments, the content partitioning system can be used to customize content to reach particular users for marketing or other purposes. Although solving the problem of spoiling forums has been discussed in detail herein, the tools provided by the system are suitable for many other uses, including advertising and marketing to particular groups of users. Once the system knows information about particular users or groups that users fall into, the system can customize content to create an experience on a web site or other property that is tailored for each user. For example, a web site that sells cars may present different content to a user in an age 20-24 demographic group than a user aged 40-45. The site may choose to highlight different products to different users, display different text or other content deemed more appealing to each user group, and so forth. As another example, a news site may adjust the length or content of articles based on information detected about a user. For example, a scientist may enjoy seeing more details or backing data behind a story related to the scientist's field and the system can present this information, while other users may appreciate a more cursory summary of the findings. The system can display the same base content in different ways to each of these different types of users.

From the foregoing, it will be appreciated that specific embodiments of the content partitioning system have been described herein for purposes of illustration, but that various modifications may be made without deviating from the spirit and scope of the invention. For example, although forums have been described in examples, the system can also be applied to other sources of online content, such as video sharing sites, photo sharing sites, product review sites, blogs, news sites, and so forth. Accordingly, the invention is not limited except as by the appended claims.

I/We claim:

1. A computer-implemented method for conditionally displaying online content to a user of an information system, the method comprising:
receiving a request to display content for a user;
identifying one or more user characteristics associated with the requesting user that determine content suitable for display to the user;
accesses one or more content items that fulfill the received request;
selecting at least one of the accessed content items;
determining a sentiment indication associated with the selected content item;
comparing the determined sentiment of the selected content item with the identified user characteristics to determine whether the selected content item is suitable display for the user;
upon determining that the content item is suitable for display to the user, marking the selected content item for display to the user; and
displaying one or more marked content items to the requesting user in response to the user's request,
wherein the preceding steps are performed by at least one processor.

2. The method of claim 1 wherein receiving the request to display content comprises receiving information describing a type of content the user requests to access.

3. The method of claim 1 wherein identifying user characteristics comprises accessing a user profile of the user that includes information related to the user.

4. The method of claim 1 wherein identifying user characteristics comprises determining that the user is an unregistered user and applying default characteristics to the user.

5. The method of claim 1 wherein identifying user characteristics comprises dynamically determining characteristics of the user.

6. The method of claim 1 wherein accessing content items comprises retrieving a list of forum posts for an online forum that the user is requesting to access.

7. The method of claim 1 wherein accessing content items comprises accessing the items from a storage facility that stores content items previously submitted by the user or other users of the system.

8. The method of claim 1 wherein determining the sentiment indication comprises accessing previously determined and assigned characteristics describing the selected content item that were determined upon submission of the item to the system.

9. The method of claim 1 wherein determining the sentiment indication comprises dynamically determining the sentiment of content items as the items are accessed.

10. The method of claim 1 wherein comparing the item sentiment to the user characteristics comprises determining whether a particular user is likely to be interested in the content item.

11. The method of claim 1 wherein comparing the item sentiment to the user characteristics comprises avoiding presenting items to the user from which the user will not derive a threshold level of value.

12. The method of claim 1 wherein marking the content item for display comprises processing multiple content items and marking some items for display to the user and not marking others to be hidden from the user.

13. The method of claim 1 wherein the displayed items exclude those items that the system determined were not suitable for display to the user, whereby the system displays some content items to some users that but does not display the same content items to other users to partition the users by characteristics.

14. A computer system for sentiment-based content aggregation and presentation, the system comprising:
a processor and memory configured to execute software instructions embodied within the following components;
a user identification component that identifies users that interact with the system;
a user profile component that stores user information across user sessions with the system;
a content submission component that receives from a user a submission of content for publication to other users;
a content storage component that stores submitted content for subsequent viewing by users of the system;
a sentiment detection component that evaluates submitted content based on one or more sentiment criteria and rates the content for suitability for display to particular users or groups of users;
a content request component that receives one or more requests to display content items to a user;
a conditional presentation component that determines one or more content items to filter from a user's view of content stored by the system; and
a user interface component that provides one or more user interfaces through which the system interacts with users of the system.

15. The system of claim 14 wherein the user identification component identifies users during a content submission phase and during a content viewing phase.

16. The system of claim 14 wherein, upon receiving a request to view content, the user identification component determines the viewing user's identity, selects appropriate content for the user, and displays the content to the user.

17. The system of claim 14 wherein, upon receiving a content submission, the user identification component determines the submitting user's identity, invokes the content submission component to evaluate sentiment of the content, and stores the submitted content.

18. The system of claim 14 wherein the user profile component is further configured to store characteristics manually or automatically determined that inform the system's decisions on how to rate and display content from the user.

19. The system of claim 14 wherein the content submission component is further configured to store information about a user that submitted the content and initiate an automated review of the content so that the content can be classified based on its content and suitability for display to particular groups of users.

20. A computer-readable storage medium comprising instructions for controlling a computer system to receive online content from an author for display to other users of an information system, wherein the instructions, upon execution, cause a processor to perform actions comprising:
receiving a content submission from an author;
identifying one or more characteristics of the content submission and the author that submitted the content;
analyzing a sentiment of the submitted content to determine one or more classifications to which the content is related;
assigning one or more content classifications to the received content that partition various content submissions between one or more classes of users to which to display the content; and
storing the received content submission along with the assigned content classifications in a data store from which the content submission can be accessed upon receiving a request to display the content submission.
